(19) United States
(12) Patent Application Publication
(10) Pub. No.: US 2026/0111515 A1
(43) Pub. Date: Apr. 23, 2026

(54) DETERMINING MULTI-DIMENSIONAL DATA DYNAMICS USING TRAJECTORY ENTROPIES

(71) Applicant: Tellagence, Inc., Oregon City, OR (US)

(72) Inventors: Nitin Mayande, Naperville, IL (US); Sharookh Daruwalla, Austin, TX (US)

(21) Appl. No.: 19/363,167

(22) Filed: Oct. 20, 2025

Related U.S. Application Data
(60) Provisional application No. 63/710,016, filed on Oct. 21, 2024.

(51) Int. Cl. G06F 17/16; G06F 17/18; H04L 41/142; H04L 41/16; H04L 45/02

(52) U.S. Cl. CPC G06F 17/16; G06F 17/18; H04L 41/142; H04L 41/16; H04L 45/08

(57) ABSTRACT

Systems and methods for determining trajectory entropies of a network, the method comprising receiving an input matrix of the network, the network comprised of a plurality of vertices and a plurality of edges; calculating, from the input matrix, an adjacency matrix; calculating, from the adjacency matrix, a number of trajectories between all vertices of the plurality of vertices; calculating trajectory probabilities of the number of trajectories; and determining, from the trajectory probabilities, a trajectory entropy for each trajectory between any two of the plurality of vertices. Other embodiments are disclosed.

### CROSS-REFERENCE TO RELATED APPLICATIONS

This application claims the benefit of U.S. Provisional Application No. 63/710,016, filed on Oct. 21, 2024, which application is hereby incorporated herein by reference.

### TECHNICAL FIELD

The present invention relates generally to artificial intelligence systems, and, in particular embodiments, to a method and associated system for determining data flow and dynamics through various types of networks using trajectory entropies.

### BACKGROUND

Machine learning and artificial intelligence (AI) technology continues to evolve into increasingly useful tools that can be applied in a variety of different domains. ML systems include a wide variety of different types of algorithms that may enable a computer system to solve various problems, potentially in an adaptive fashion. ML systems may include statistical algorithms that can extrapolate patterns and/or general behaviors from specific data in a predictive fashion. AI technology, which is a subset or type of ML, includes a variety of different techniques and algorithms, including different networks that may be used to implement machine learning, including (but not limited to) artificial neural networks (ANN). A subset of ANNs, for example, includes generative neural networks which, as the name suggests, can create various types of output based on an input prompt. Types of generative neural networks include large language models (LLMs), such as ChatGPT, and image generators, such as DALL-E, among others. For generally accessible implementations of generative AI systems such as ChatGPT and DALL-E, the systems are typically trained on vast amounts of data relevant to the AI system's operative modality, viz. text, images, etc., that may span a variety of different information domains. Other systems may be trained on more specific domains to form an expertise in a particular area. For example, some LLMs may be trained on social network data to provide predictive expertise on user behavior.

Information Propagation, the spread and dissemination of information, has always been a cornerstone of human society. With the advent of AI, this process has undergone a profound transformation. AI technologies are not only accelerating the speed and scope of information propagation but also fundamentally changing the ways in which we interact with and consume information. Therefore, the effectiveness of AI greatly depends on its ability to learn.

Information propagation and AI learning are inextricably linked, forming a symbiotic relationship. As information flows freely and efficiently, AI systems can access vast datasets, enabling them to learn, adapt, and improve their capabilities. Conversely, AI-powered tools and algorithms can accelerate the dissemination of information, making it more accessible and relevant to users. It is therefore evident that the quality of AI output vastly depends on the how well a given AI is able to learn and/or reason.

The background description provided herein is for the purpose of generally presenting the context of the disclosure. Unless otherwise indicated herein, the materials described in this section are not prior art to the claims in this application and are not admitted to be prior art by inclusion in this section.

### SUMMARY

According to a first aspect, a method for calculating a trajectory entropy of a network comprises receiving an input matrix of the network, the network comprised of a plurality of vertices and a plurality of edges. An adjacency matrix is calculated from the input matrix, and a number of trajectories between all vertices of the plurality of vertices are calculated from the adjacency matrix. Trajectory probabilities of the number of trajectories are calculated, and a trajectory entropy for each trajectory between any two of the plurality of vertices is determined from the trajectory probabilities.

With reference to the first aspect, in a first possible embodiment, the network is a directed network.

With reference to the first aspect, in a second possible embodiment, the directed network is a weighted directed network.

With reference to the first aspect, a third possible embodiment comprises determining, for each vertex, an accessibility potential and a propagation potential.

With reference to the first aspect, in a fourth possible embodiment, calculating an adjacency matrix comprises calculating a plurality of adjacency matrices, each of the plurality of adjacency matrices corresponding to an order of adjacency.

With reference to the first aspect, a fifth possible embodiment comprises receiving a tie strength matrix, and calculating the trajectory probabilities of the number of trajectories comprises generating, from the tie strength matrix, a normalized tie strength matrix; and calculating, from the tie strength matrix and the number of trajectories, a trajectory tie strength matrix.

With reference to the first aspect, a sixth possible embodiment comprises generating, from the trajectory tie strength matrix and the trajectory probabilities, a modified trajectory probability matrix.

According to a second aspect, a non-transitory computer-readable medium comprises instructions that, when executed by one or more processors, cause the one or more processors to perform receiving an input matrix of a network, the network comprised of a plurality of vertices and a plurality of edges; calculating, from the input matrix, an adjacency matrix; calculating, from the adjacency matrix, a number of trajectories between all vertices of the plurality of vertices; calculating trajectory probabilities of the number of trajectories; and determining, from the trajectory probabilities, a trajectory entropy for each trajectory between any two of the plurality of vertices.

With reference to the second aspect, in a first possible embodiment, the network is a directed network.

With reference to the second aspect, in a second possible embodiment, the directed network is a weighted directed network.

With reference to the second aspect, in a third possible embodiment, the instructions further cause the one or more processors to perform determining, for each vertex, an accessibility potential and a propagation potential.

With reference to the second aspect, in a fourth possible embodiment, calculating an adjacency matrix comprises calculating a plurality of adjacency matrices, each of the plurality of adjacency matrices corresponding to an order of adjacency.

With reference to the second aspect, in a fifth possible embodiment, the instructions further cause the one or more processors to perform receiving a tie strength matrix, and calculating the trajectory probabilities of the number of trajectories comprises generating, from the tie strength matrix, a normalized tie strength matrix; and calculating, from the tie strength matrix and the number of trajectories, a trajectory tie strength matrix.

With reference to the second aspect, in a sixth possible embodiment, the instructions further cause the one or more processors to perform generating, from the trajectory tie strength matrix and the trajectory probabilities, a modified trajectory probability matrix.

According to a third possible aspect, a system for determining trajectory entropies of a network comprises one or more processors; and a storage medium in data communication with the one or more processors, the storage medium containing instructions that, when executed by the one or more processors, cause the system to perform receiving an input matrix of the network, the network comprised of a plurality of vertices and a plurality of edges; calculating, from the input matrix, an adjacency matrix; calculating, from the adjacency matrix, a number of trajectories between all vertices of the plurality of vertices; calculating trajectory probabilities of the number of trajectories; and determining, from the trajectory probabilities, a trajectory entropy for each trajectory between any two of the plurality of vertices.

With reference to the third aspect, in a first possible embodiment, the network is a directed network.

With reference to the third aspect, in a second possible embodiment, the instructions further cause the one or more processors to perform determining, for each vertex, an accessibility potential and a propagation potential.

With reference to the third aspect, in a third possible embodiment, calculating an adjacency matrix comprises calculating a plurality of adjacency matrices, each of the plurality of adjacency matrices corresponding to an order of adjacency.

With reference to the third aspect, in a fourth possible embodiment, the instructions further cause the one or more processors to perform receiving a tie strength matrix, and calculating the trajectory probabilities of the number of trajectories comprises generating, from the tie strength matrix, a normalized tie strength matrix; and calculating, from the tie strength matrix and the number of trajectories, a trajectory tie strength matrix.

With reference to the third aspect, in a fifth possible embodiment, the instructions further cause the one or more processors to perform generating, from the trajectory tie strength matrix and the trajectory probabilities, a modified trajectory probability matrix.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings, in which:

FIG. 1 is a flow chart of an example method for computing trajectory entropies of a network, such as may comprise an artificial neural network, according to various embodiments;

FIG. 2 is an example network on which the disclosed embodiments, such as the example method of FIG. 1, may be used;

FIG. 3 is an example input matrix illustrating tie weights of the example network of FIG. 2, according to various embodiments;

FIG. 4 is an example adjacency matrix for the various vertices of the example network of FIG. 2, according to various embodiments;

FIG. 5 is an example matrix illustrating normalized tie weights of the example network of FIG. 2, according to various embodiments;

FIG. 6 is a table illustrating the out-degrees and in-degrees of the various vertices of the example network of FIG. 2, according to various embodiments;

FIG. 7 illustrates first order, second order, and third order adjacency matrices along with associated path order matrices for the vertices of the example network of FIG. 2, according to various embodiments;

FIG. 8 illustrates the first order, second order, and third order adjacency matrices and associated path order matrices of FIG. 7, along with first, second, and third order shortest path matrices for the vertices of the example network of FIG. 2, according to various embodiments;

FIG. 9 illustrates the shortest paths between the various vertices of the example network of FIG. 2, according to various embodiments;

FIG. 10 illustrates out-degree, in-degree, and α and β factors for determining probabilities for the various vertices of the example network of FIG. 2, according to various embodiments;

FIG. 11 is an example matrix of trajectory probabilities for the various vertices of the example network of FIG. 2, according to various embodiments;

FIG. 12 is an example matrix of tie strengths for trajectories between the various vertices of the example network of FIG. 2, according to various embodiments;

FIG. 13 is an example modified probability matrix for the various vertices of the example network of FIG. 2, according to various embodiments;

FIG. 14 is an example matrix of trajectory entropic values for the various vertices of the example network of FIG. 2, according to various embodiments;

FIG. 15 is a table of the accessibility potential and propagation potential of each of the vertices of the example network of FIG. 2 as computed from the trajectory entropic values of FIG. 14, according to various embodiments;

FIG. 16 is a block diagram of an example computer that can be used to implement some or all of the components of the disclosed systems and methods, according to various embodiments; and

FIG. 17 is a block diagram of a computer-readable storage medium that can be used to implement some of the components of the system or methods disclosed herein, according to various embodiments.

### DETAILED DESCRIPTION OF ILLUSTRATIVE EMBODIMENTS

The various ways in which information flows (“flow types”) can be distinguished by two properties: the routes through which the traffic flows, and the method by which the flows are propagated. Routes are important because, for example, in some flow processes it is desirable for traffic to flow over the shortest possible routes (as in a package delivery system), whereas in other flows the traffic meanders aimlessly (as in gossip passing through a communication network). Methods of propagation, too, differ among networks. For example, the propagation of an e-mail chain letter, which gets sent simultaneously to a list of e-mail addresses, is quite different than that of a traditional, paper-based chain letter, which is sent to one person at a time. Routes may be classified into 4 types:
Paths: A path is a sequence of distinct nodes, with each node in the sequence being a neighbor of the preceding node. If one travels from the first node in the path to the last by following ties (edges), then the number of ties that are traveled is the path's length.
Geodesics: There might be multiple paths of varying lengths from one node to another, and a shortest path amongst such paths is called a geodesic.
Trails: A trail is like a path, except nodes can be visited more than once.
Walks: A walk is the most general type of route, where it is permissible both for nodes to be visited more than once and for ties to be traveled more than once.
Methods of Propagation can be classified into 3 types:
Parallel Duplication Propagation: Propagation occurs by replicating what is at one node to multiple neighbors of the node simultaneously. Example of this process is forwarding email to everybody on the mailing list simultaneously.
Serial Duplication Propagation: Propagation occurs by replicating what is at one node to multiple neighbors of the node one at a time. Example of this process is gossip network amongst friends. A communicator might pass the gossip to a friend, and then to another, and then to another.
Transfer: Propagation of this type allows the traffic to be in only a single location at any point in time. An object being passed from node to node (for example a package delivery system where the package exists in only one place at a time).

Based on the classification of the Routes and the Method of Propagation, Table 1 illustrates a possible typology for the flow process:

TABLE 1
Typology of Flow Process

| | Parallel duplication | Serial duplication | Transfer |
|---|---|---|---|
| Geodesics | <No process> | Mitotic reproduction | Package delivery |
| Paths | Internet server | Viral infection | Mooch |
| Trails | E-mail broadcast | Gossip | Used goods |
| Walks | Attitude influencing | Emotional support | Money exchange |

The combination of the routes (through a given network or graph, such as an artificial neural network) and the method of propagation lead to varied phenomena. This combination is defined as a Trajectory.

Information Entropy is a measure of uncertainty or randomness in a system. It quantifies the average amount of information needed to specify the outcome of an event. In simpler terms, it represents the degree of surprise or unexpectedness associated with a particular outcome. A system with high entropy has many possible states, making it difficult to predict its exact configuration. Conversely, a system with low entropy has fewer possible states, making it easier to predict. The disorder or randomness also means freedom of choice. The higher the entropy, the higher the freedom of choice and the lower the entropy, the lower the freedom of choice.

The mathematical formula for information entropy is:

$$H ( X ) = - \sum p ( x ) {log}_{2} p ( x )$$

where H(X) is the entropy of variable X, p(x) is the probability of the outcome x, Σ is the summation over all possible outcomes of x, and log₂ is the base-2 logarithm. Embodiments discussed below adapt and apply this concept of information entropy to networks/graphs, which comprise trajectory entropies.

As used herein, the terms “network” and “graph” are synonymous and may be used interchangeably. “Graph” or “network” refers to a structure comprised of a plurality of nodes or vertices that are variously connected by edges. It should be understood that graphs and networks may be of any type that is compatible with or may be adapted to the various embodiments disclosed herein, such as undirected graphs, directed graphs, weighted, unweighted, open, closed, etc. Furthermore, “network” as used herein is not intended to be limited to a particular type of network (such as a neural network), but rather to any type of network for which the techniques disclosed herein may be applied. For example, in addition to neural networks, other possible network types could be agentic networks, such as where multiple AI models or agents collaborate (e.g. a system that may use multiple different types of networks, at least some of which may be trained or configured to respond to specific domains) to collectively address a question. The techniques disclosed herein may be adapted to such different types of networks without departing from the spirit of the invention.

Similarly, as used herein the terms “vertex” and “node” are synonymous and may be used interchangeably. A “vertex” or “node” refers to a structure within a graph or network that is interconnected to other vertices or nodes by one or more edges or ties. The vertex or node may perform processing on any data it receives prior to forwarding the data along one or more of the edges or ties to another vertex or node, according to the particular purpose and/or function of the network or graph of which the vertex or node is a part. Further, a vertex or node receiving information may, based on any programmed logic associated with a given embodiment or implementation of the network, determine to pass the data on or obstruct information flow to any adjacent nodes/vertexes. This determination may be made on the basis of any programmed rules or configurations for the vertex or node, either individually and/or as part of a broader set of configuration rules for the network or graph. Herein, the term “vertex” is generally used for the sake of consistency, but it should be understood that “node” could equally be used.

In order to improve the AI learning and reasoning ability, disclosed embodiments include methods and systems of AI learning and reasoning using Trajectory Entropies (TE). Disclosed embodiments provide for the computation of TEs for various paths through a network, such as an artificial neural network (ANN) that may implement AI learning and/or reasoning. These TEs can provide insight into like paths that data will take propagating through a given AI network, which in turn can help guide refining and tuning of the AI network. More specifically, TEs are based the probability of information flowing/passing or stopping at a given node or vertex in the AI network. In various embodiments, TE may be applied to a directed network or graph, although a person skilled in the art may adapt various aspects of this disclosure to other types of graphs or networks, such as undirected graphs or networks (which may be conceived of as a directed network where any two adjacent vertexes are always connected by a bi-directional edge).

TE measures the uncertainty associated with the flow of information between nodes in a network. The calculation involves computing the probabilities of information flow based on the network structure, tie strengths between nodes, and types of trajectories. Accessibility Potential (AP) and Propagation Potential (PP) are defined based on TE values. These concepts can be used to determine the relative positional encoding within data, which can be useful in various applications, such as AI learning and reasoning tasks, including:
Feature engineering: TE, AP, and PP can be used to create new features for machine learning models. These features can capture the information flow dynamics in the data, which can improve the accuracy of the models.
Data visualization: TE, AP, and PP can be used to visualize the information flow in a network. This can help to understand the relationships between different nodes in the network and to identify important nodes.
Network analysis: TE, AP, and PP can be used to analyze the structure of a network and to identify important nodes and edges. This can be used to understand the flow of information in the network and to make predictions about how the network will behave.
Natural language processing: TE, AP, and PP can be used to analyze text data and to identify the relationships between different words and concepts. This can be used to improve the accuracy of natural language processing tasks such as machine translation and text summarization.
Social network analysis: TE, AP, and PP can be used to analyze social networks and to identify important people and groups. This can be used to understand the flow of information in the network and to make predictions about how people will behave.

Overall, the foregoing method and implementing systems can be used to improve the accuracy and efficiency of AI learning and reasoning by providing a way to quantify the information flow dynamics in data.

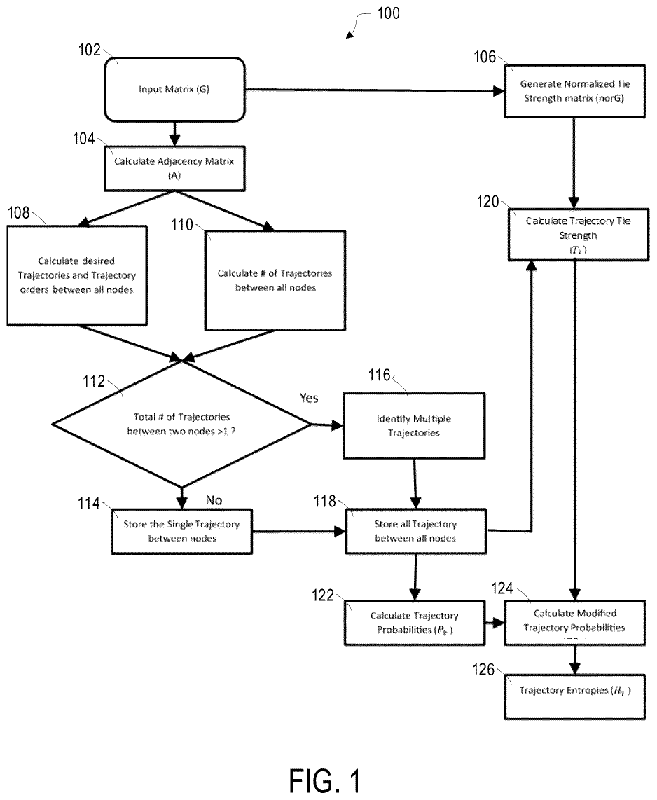

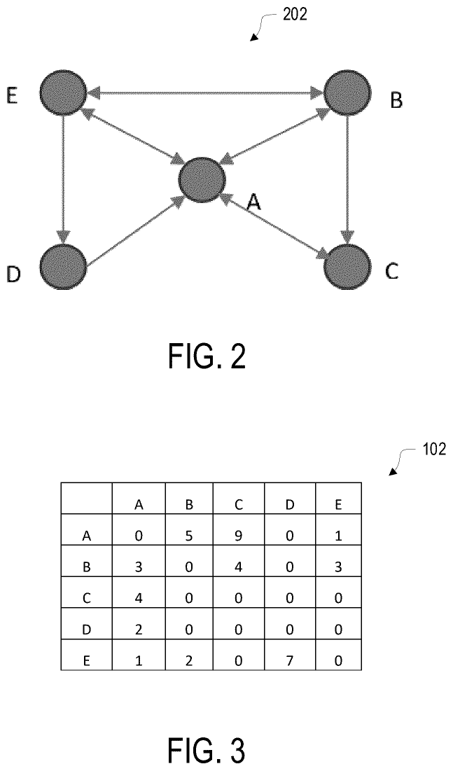

FIG. 1 illustrates a flow chart of operations of a process 100 for determining the trajectory entropies of a network, according to one possible embodiment. Process 100 begins with obtaining an input matrix 102, which represents a plurality of ties (edges) as well as the weights of the plurality of ties between a plurality of vertices of the network. An example of a network 202 represented by input matrix 102 is illustrated in FIG. 2, and the input matrix 102 itself is illustrated in FIG. 3. As can be seen, network 202 is comprised of five vertices {A, B, C, D, E}, each of which are connected by ties or edges {(A,B), (A,C), (A,E), (B,A), (B,C), (B,E), (C,A), (E,A), (E,B), (E,D), (D,A)}. These relationships can be expressed as G=(V, E), where G is a network (directed, in the case of network 202), V is a finite and non-empty set of vertices or nodes (the five vertices listed above), and E is a finite and non-empty set of edges or ties (the edges listed above).

Note that because the example network 202 is a directed graph, two-way ties or edges are indicated twice, once for each direction, e.g. the two-way tie between A and B is represented as a pair (A,B) and a pair (B,A). Put another way, for a given edge defined by a pair of vertices i and j, (i, j)≠(j, i). As can be seen from the input matrix 102 in FIG. 3, each tie or edge has a weight that may differ between two given nodes depending on the direction. For example, edge (A, B) has a weight of 5, while edge (B, A) has a weight of 3. In other embodiments, a non-directed network may have edges such that (i, j)=(j, i). Further, for example networks that may include loops, a given tie or edge has a single vertex as both the start and finish, and so i=j.

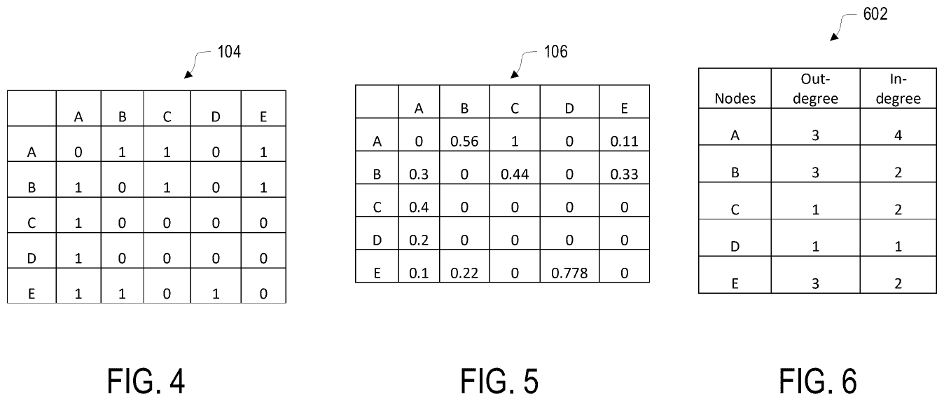

From this input matrix 102, one or more adjacency matrices 104 may be calculated. Adjacency may be understood as the proximity between two vertices. An adjacency matrix is a matrix representation of a network displaying connectivity of the network. If two vertices are incident with the same edge, e.g., (A, B), (A, C), (B, C), etc., of network 202, they are considered adjacent or neighbors. An adjacency matrix may comprise an N×N matrix, where N is the number of V vertices. An example adjacency matrix 104 is illustrated in FIG. 4. The rows and columns of the matrix are labeled by the vertices (nodes). Each cell in the adjacency matrix 104 represents a possible edge or tie based on its row and column, Thus, the possible edge (A, B) is represented by the second column of the first row, and the possible edge (B, A) is represented by the first column of the second row; as discussed above, (A, B)≠(B, A) because the network 202 is directed. The adjacency matrix is determined as follows: for each cell where there is a link between two vertices, e.g., an edge (i, j)∈E, a 1 (one) is entered, and for each cell where there is no link, e.g., the possible edge (i, j) is not an element of E, a 0 (zero) is entered. Thus, as there are no loops in network 202, each pair (A, A), (B, B), (C, C), (D, D), and (E, E) are zero. Likewise, a one is entered for the edge (B, C), but a zero is entered for the edge (C, B), because network 202 has a directed edge from vertex B to vertex C, but no reciprocal path.

It will be appreciated that the adjacency matrix 104 is a first order adjacency matrix, viz. it depicts the number of ways the various vertices connect to each other directly, without any intervening node between them. Furthermore, the out-degree and in-degree of a given vertex or node may be computed from the first order adjacency matrix 104. The out-degree is the number of outbound ties or edges from a given vertex (i.e., the number of ties or edges for which the given vertex is the source or start), while the in-degree is the is the number of inbound ties or edges to a given vertex (i.e., the number of ties or edges for which the given vertex is a destination or end). Accordingly, for a given vertex, the out-degree can be computed from the adjacency matrix 104 by adding the number of 1s (ones) in the vertex's row, and the in-degree can be computed from the adjacency matrix 104 by adding the number of 1s (ones) in the vertex's column. With respect to the example adjacency matrix 104, the out-degree and in-degree are illustrated in the table 602 of FIG. 6. As can be seen, for vertex A, as an example, the out-degree is 3, which reflects the presence of ties for (A, B), (A, C), and (A, E) in adjacency matrix 104, and the in-degree is 4, which reflects the presence of ties for (B, A), (C, A, (D, A), and (E, A). Referring to network 202 of FIG. 2, from which the adjacency matrix 104 is obtained, the presence of three outbound ties from A to vertices B, C, and E can be seen, while A has four inbound ties from vertices B, C, D, and E, which correlates with the entries in adjacency matrix 104 and table 602.

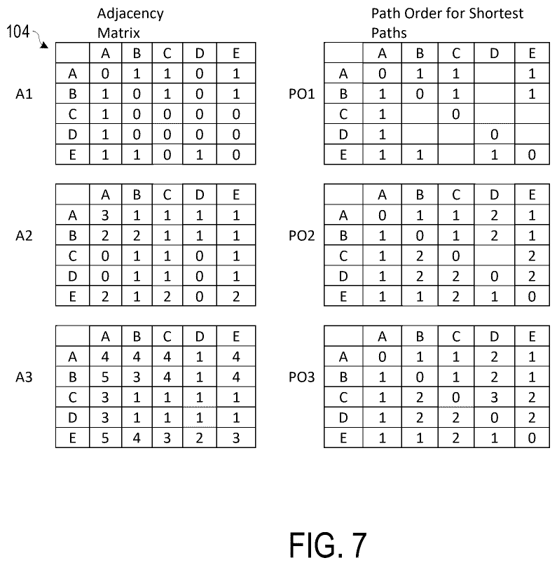

As may be seen from the network 202, not all vertices are directly accessible to each other. For example, vertex C is not directly accessible to vertices D or E or, for that matter, B, as network 202 is a directed network. However, these vertices may be accessible to data traversing vertex C by one or more intermediate vertices, viz. via indirect connection. This relationship is not displayed in the example adjacency matrix 104, which is a first order adjacency matrix, as mentioned above. However, a second order adjacency matrix can indicate connections where there is one intermediate vertex on a path or trajectory from a first vertex Vᵢ to a second vertex Vⱼ. A second order adjacency matrix can be derived as follows:

$$A 2 = A 1 * A 1$$

where A1 is a first order adjacency matrix, and A2 is the second order adjacency matrix. Referring to FIG. 7, the adjacency matrix 104 is shown as first order adjacency matrix A1. Using the formula above, second order adjacency matrix A2 is obtained from the first order adjacency matrix A1. A second order path is a path that passes through one intermediate vertex between the source vertex and destination vertex. With reference to the disclosed example embodiments, A1 is the adjacency matrix 104. When multiplied by itself the second order adjacency matrix is obtained. With reference to the network 202 of FIG. 2, vertex A can reach back to itself (e.g. loop) via three possible paths, (A, B, A), (A, C, A), and (A, E, A); hence, the cell for (A, A) indicates 3, reflecting these three possible paths. It should be understood that the first order adjacency matrix A1 indicated zero, as there are no direct loops back into vertex A. The cell for (B, A) indicates 2, reflecting two possible second order paths: (B, C, A), and (B, E, A). It should be understood that the first order adjacency matrix A1 indicated one possible path, the direct tie of (B, A), reflected in the cell for (B, A) indicating 1 in matrix A1; the second order adjacency matrix A2 indicates 2 to reflect the two second order paths listed above. Correspondingly, the cell for vertex B indicates 2, corresponding to (B, A, B) and (B, E, B); the cell for vertex C indicates 1, corresponding to (C, A, C), and the cell for vertex E indicates 2, corresponding to (E, A, E) and (E, B, E). The cell for vertex D still indicates 0 (zero), as there are no paths that lead back to D that only require a single intermediate vertex.

Extending the concept to higher-order adjacency matrices, a third order adjacency matrix can be derived as follows:

$$A 3 = A 1 * A 2$$

where A1 is the first order adjacency matrix, and A2 is the second order adjacency matrix. A third order path is a path that passes through two intermediate vertices between the source and destination vertices. It will be appreciated that, alternatively, the third order adjacency matrix can be obtained by multiplying the first order adjacency matrix by itself three times, as A2 is obtained by multiplying A1 by itself. The third order adjacency matrix is shown as matrix A3 in FIG. 7. Considering third order adjacency matrix A3, it can be seen that there are now four possible paths indicated in the cell for vertex A, corresponding to the third order paths of (A, B, C, A), (A, B, E, A), (A, E, B, A), and (A, E, D, A). It will be understood that vertices B and E form two of the third order paths as vertices A, B, and E are each interconnected by bi-directional links; there is no reciprocal or reverse path using vertices C or D, as the third order paths through each vertex traverse at least one uni-directional link. Similarly, the cell for the path (B, A) indicates five possible third order paths: (B, E, D, A), (B, A, E, A), (B, A, C, A), (B, E, B, A), and (B, A, B, A). Vertex C can loop to itself by a single path (C, A, B, C), and vertex D can loop to itself by the single path (D, A, E, D). It should be noted that all but one of the possible third order paths from B to A pass through a same node at least twice; it is not a requirement in the depicted examples that each path only visit each vertex once, just that two intermediate vertices are visited between the source and destination vertices.

It can be seen from FIG. 7 that all cells in the third order adjacency matrix A3 are now non-zero, indicating that the diameter of network 202 is 3, corresponding to the highest number of hops or path length of the shortest paths through network 202 where all nodes can be reached by any other node, viz. any node can reach any other node in the example network 202 by a maximum of three hops.

Still referring to FIG. 7, a first order path matrix PO1, a second order path matrix PO2, and a third order path matrix PO3 can be derived from their corresponding adjacency matrices A1, A2, and A3, respectively. A path order matrix is an adaptation of an adjacency matrix. A path order matrix holds the shortest path between nodes of a network, which are either less than or equal to the diameter of the network. With respect to the example embodiments, the path order matrices indicate the shortest possible path between a given set of vertices through the example network 202 at a given order of path length (all cells corresponding to where a vertex Vᵢ is equal to a vertex Vⱼ, such as the cell for (A, A), are indicated as zero, because no path is necessary when the same vertex is both source and destination). Thus, the first order path matrix PO1 indicates the availability of a first order (direct) path between any two vertices as the number 1, with boxes being blank where no first order (direct) path is available.

The second order path matrix PO2 indicates the availability of either a direct path or path with only a single intermediate vertex between any two vertices, with a direct path between any two vertices indicated as 1 in the corresponding cell, and a path that requires a single intermediate vertex indicated as 2 in the corresponding cell. As with the first order path matrix, a cell is left blank where no first order or second order path is available.

Similarly, the third order path matrix PO3 indicates the availability of a direct path (first order), a path with one single intermediate vertex (second order), or a path with two intermediate vertices (third order) as the shortest path between any two vertices. Thus, (C, A) has a 1 (one), because C is directly connected to A; (C, B) has a 2, because the shortest path from C to B must go through A (the direct path between B and C is unidirectional, flowing only from B to C); and (C, D) has a 3, because the shortest path from C to D must go through A and E.

It can be observed that all cells in PO3 are filled, corresponding to the diameter of the network 202 of three. Put differently, a path order matrix indicates the shortest possible path, if one is available, between two vertices of a network at or below a given order. It should be understood that each path order matrix at a given order is cumulative of all lower-order path order matrices. With reference to the example illustrated in FIG. 7, the second order path order matrix also indicates all first order paths, and the third order path order matrix also indicates all first and second order paths.

Algorithmically, the Floyd-Warshall Algorithm may be used to identify a network diameter and all shortest paths between all vertices for the path order matrix. The path order matrix is constructed as follows:

The first order path order matrix (PO1) is constructed from the first order adjacency matrix A1, where all the direct links are kept. The number 1 in the path order matrix indicates that the shortest path is of a 1^{st} order (path length is 1). The diagonal elements are assigned the values of 0, as the shortest distance between a vertex and itself is 0, as discussed above. The cells which have a value of 0 in the A1 matrix are left blank (except for the aforementioned diagonal elements where the cells represent a single vertex, e.g. Vᵢ=Vⱼ), as the shortest path between those nodes is yet to occur.

The second order path order matrix (PO2) is built from the empty cells of PO1 and the A2 matrix. A value of 2 is assigned to the empty cells of PO1 for which the corresponding values in A2 are greater than 0 (zero). The number 2 in the PO2 indicates that the shortest path is of a 2^{nd} order (path length is 2). The third order path order matrix (PO3) is likewise built from the empty cells of PO2 and the A3 matrix, with a value of 3 assigned to the empty cells of PO2 for which the corresponding values in A3 are greater than 0 (zero). The number 3 in the PO3 indicates that the shortest path is of a 3^{rd} order (path length is 3).

Since all the cells in PO3 are occupied, we have identified that the highest path length of shortest paths in the network is 3. Therefore, the diameter of the network is 3. It should be understood by a person skilled in the art that the foregoing techniques are illustrated in an example fashion, and may be extended to networks that have greater or lesser orders of adjacency. For example, in practical application a network may require sixth, seventh, eighth, ninth, . . . . Nth different orders to reach the network diameter, and the foregoing matrices and processes would be repeated iteratively for each successively higher order until the network diameter is reached and the highest order path order matrix is fully filled.

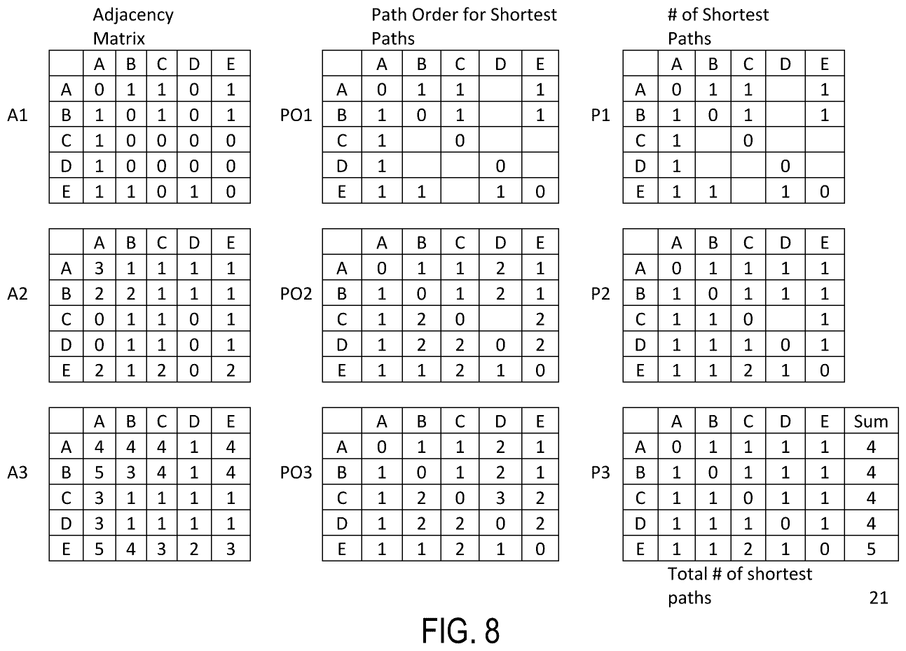

Turning to FIG. 8 and still using network 202 as an example embodiment, the adjacency matrices and path order matrices can be compared to generate shortest path matrices. The path order matrices (PO1, PO2, PO3) give the shortest path orders, and the adjacency matrices (A1, A2, A3) give the total number of paths with specific path lengths. In matrix P1 we identify the shortest path of 1st order, and in matrix P2 we fill the empty cells of P1 with the shortest paths of 2nd order. For example, consider (C,D) in PO3, which indicates that the shortest path from C to D is a 3rd order path, and from P3 we get to know that there is only one path of 3rd order from C to D. This is important, as some nodes may have multiple shortest paths between them, like (E,C) which has 2 shortest paths of 2nd order from E to C, namely (E, A, C) and (E, B, C). It will further be appreciated that as tables P1-P3 identify the total number of shortest paths for a given order, it does not reflect that a given pair of vertices may have many more possible paths with a greater number of intermediate vertices. In cases where there are multiple shortest paths between two nodes, the Hoffman-Pavley Algorithm may be used to identify the multiple shortest paths. Finally, next to matrix P3 is indicated a summation of the quantities of shortest paths between various pairs of vertices, with a total number of shortest possible paths considering all vertices of the network 202 being provided as the summary of the number of paths identified in matrix P3.

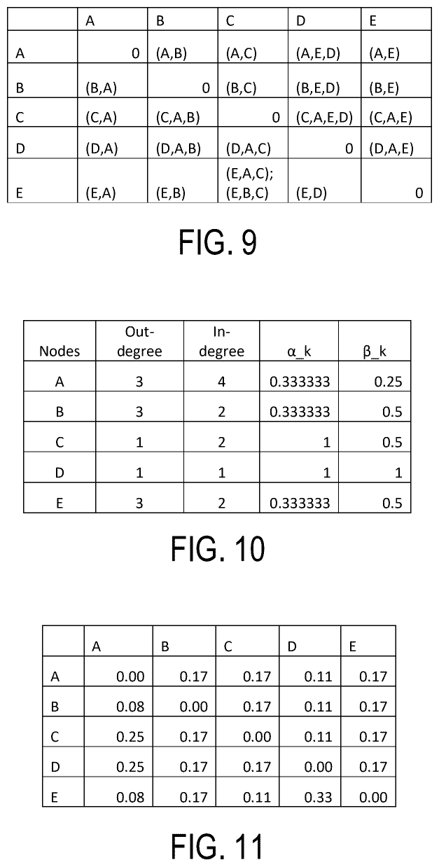

The various shortest paths that correspond to the number of shortest paths identified in matrix P3 are listed in FIG. 9. It can be seen that the number of listed paths in each cell of the FIG. 9 table corresponds to the number of shortest paths indicated in matrix P3 of FIG. 8. Each of the cells (apart from the diagonals indicating a single vertex) lists one path as matrix P3 only indicated a single shortest path except for (E, C), which identifies two paths corresponding to two indicated shortest paths in matrix P3, namely (E, A, C) and (E, B, C), as discussed immediately above.

Referring back to FIG. 1, after the adjacency matrix 104 is calculated, desired trajectories and trajectory orders between all vertices/nodes are calculated 108, and the number of trajectories between all vertices are calculated 110. These two calculated values from 108 and 110 are evaluated 112 to determine whether the total number of trajectories between any two given vertices is greater than one. If not, the single trajectory between the two vertices is stored 114, and if there are multiple trajectories 116, all trajectories between all vertices are stored 118. Consequently, trajectories from pairs of vertices with only a single trajectory and from pairs of vertices with multiple trajectories are stored. Examples of vertex pairs with both single and multiple trajectories are illustrated in FIGS. 7 and 8.

A normalized tie strength matrix 106 may be generated from the input matrix 102. The normalized tie strength matrix 106 may be generated, according to some embodiments, as follows: A network G, such as network 202 that is a directed graph, may be defined as G=(V, E), where V is a finite and non-empty set of vertices, and E is a finite and non-empty set of edges between any two vertices from V, such that a given edge V(i, j) is an element of E, and Vᵢ and Vⱼ are both elements of V. In the set of edges E, Vₘₐₓ is the maximum value of V(i, j) from the set of edges E. Normalized values for each edge V(i, j) from E are determined with the equation:

$$norG = \frac{V ( i , j )}{V max}$$

where norG is the normalized tie strength matrix, and both i and j are (1, 2, 3, . . . . N), where N is the total number of vertices in V. In the case of a network that may have a loop, defined where i=j, the value of norG would be zero.

An example of a normalized tie strength matrix 106 generated from input matrix 102 (illustrated in FIG. 3) is illustrated in FIG. 5. Referring to FIG. 3, it can be seen that Vₘₐₓ is edge (A, C), which has a weight of 9. Each cell in the input matrix 102 of FIG. 3 is divided in turn by 9, to obtain the resulting normalized tie strength matrix 106 of FIG. 5. Thus, we can see that edge (A, C) has a normalized weight of 1 (9 divided by 9), each cell with a zero weight (due to lack of a tie or edge associated with the vertex pair represented by the cell) has a value of zero (0 divided by 9), and the remaining cells have a value between zero and one. The elements of the norG matrix are the relative and normalized tie strengths between the elements of G. This normalized tie strength matrix 106 may subsequently be used to calculate the tie strength of a given trajectory through the network 102; this will be discussed further below.

From this normalized tie strength matrix 106, the tie strength of the various stored trajectories between all nodes 118 can be determined 120 according to various embodiments, as follows: Let there be K(i, j) trajectories from Vᵢ to Vⱼ. Let Taₖ be such a trajectory, where Taₖ={Vᵢ, Vᵢ₂, Vᵢ₃, . . . Vₜ, . . . Vⱼ} and let the trajectory be of length nₖ=n(k). The tie strength of a trajectory Taₖ (represented by Tₖ) is then a product of tie strengths between the ties of adjacent vertices {(Vᵢ, Vᵢₜ), (Vᵢ₁, Vᵢ₂), . . . (Vₜ, Vₜ₊₁), . . . (Vⱼ₋₁, Vⱼ)}. This can be calculated with the following equation:

$${T}_{k} = {\prod }_{i = 1}^{j} ( {V}_{i} , {V}_{i + 1} )$$

where Vᵢ is the first node or vertex on a path Paₖ (that defines trajectory Taₖ), and Vᵢ₊₁ is the next node on path Paₖ.

As mentioned above, data passing through a network, such as network 202, may follow a path dictated by a particular task to be performed on the data. This task and associated path in turn may determine an information flow rule or rules for the network, and may be specific to a given network. To determine a particular appropriate flow rule for a given network, the probability that the data may follow a particular trajectory through the network may be determined. Consequently, in embodiments, the trajectory probabilities for each stored trajectory may be calculated 122, which may be based on the out-degree and in-degree for each vertex, such as illustrated in table 602 of FIG. 6.

The in-degree Dᵢₙ of a given vertex V, where V={1, 2, 3, . . . N}, may be calculated as follows:

$$Din ( {V}_{i} ) = {\sum }_{j = 1}^{N - 1} {a}_{{v}_{i , j}}$$

where av_{i,j} is an element of the adjacency matrix 104, and equals 0 (zero) when no directed edge exists between i and j, or i=j (diagonal of the adjacency matrix 104), and equals 1 (one) when a direct edge exists between i and j, and i does not equal j. This equation counts the total number of edges incident on a node or vertex that are coming in. Similarly, the out-degree Dₒᵤₜ may be calculated as follows:

$$Dout ( {V}_{i} ) = {\sum }_{i = 1}^{N - 1} {a}_{{v}_{i , j}}$$

where av_{i,j} has the same definitions as above. This equation counts the total number of edges incident on a node or vertex that are going out. The values for each of these equations for each node of a network, such as network 202, form the data points of the table 602, as shown in FIG. 6. At any point in the flow, a vertex receiving information can determine to pass on or obstruct the information flow to any of its adjacent vertices. The degree gives information about the number of adjacent vertices to which a given vertex is connected.

Trajectory probabilities may be calculated 122 as follows:

For a given network, such as example network 202, there may be K(i, j) trajectories between given vertices Vᵢ to Vⱼ. Similar to the process described above for determining 120 the tie strength of a trajectory, a given trajectory may be Paₖ, which may equal {Vᵢ, Vᵢ₂, Vᵢ₃, . . . Vₜ, . . . Vⱼ}, with a trajectory having a length nₖ=n(k). The probability of information passing through a given vertex Vₜ which is within the trajectory Paₖ, may be determined by:

$${α}_{k} ( {V}_{t} ) = \frac{1}{Dout ( {V}_{t} )}$$

Similarly, the probability of information stopping (rather than passing) through the vertex Vₜ may be determined by:

$${β}_{k} ( {V}_{t} ) = \frac{1}{Din ( {V}_{t} )}$$

In embodiments where the network may be undirected (e.g. each edge is bi-directional in flow), the stopping probability is the same as the passing probability. However, where the network is directed, these probabilities may be different as suggested by different tie strengths and as expressed in the different in-degree and out-degree.

With respect to the example network 202, FIG. 10 indicates the out-degree, in-degree, αₖ, and βₖ associated with the various vertices A to E, after calculation with the adjacency matrix 104.

The probability Pₖ of a given single path Paₖ may then be determined by multiplying the probabilities of information passing through each vertex Vᵢ to Vⱼ₋₁ that lies on trajectory Paₖ, and the stopping probability of the final vertex Vⱼ. The results K(i, j) are the total paths between vertex Vᵢ and vertex Vⱼ. Thus, the trajectory probability Pₖ of path Paₖ may be determined from the previous two equations by:

$${P}_{k} = {β}_{k} ( {V}_{j} ) {\prod }_{t = 1}^{j - 1} {α}_{k} ( {V}_{t} )$$

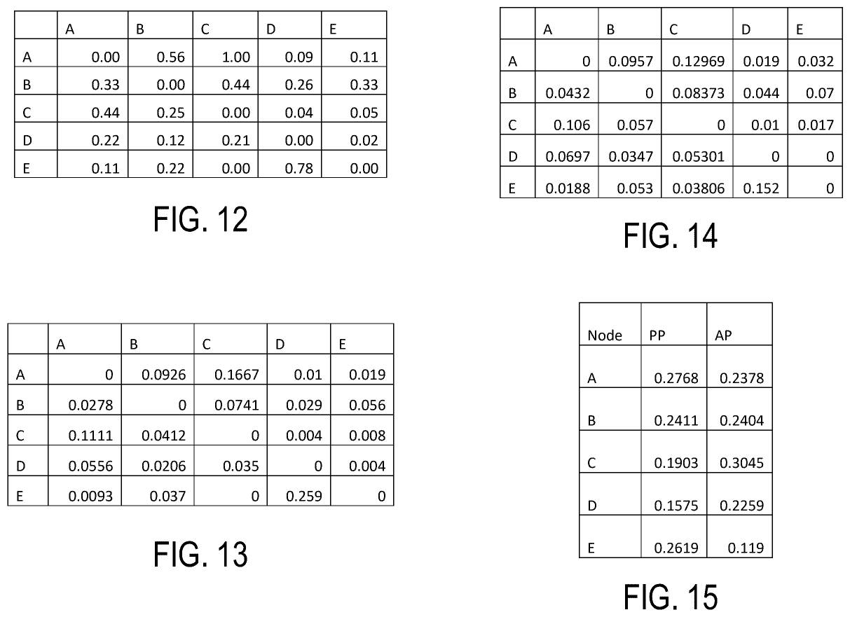

As can be seen, the trajectory probabilities are computed using αₖ and βₖ determined above, and as indicated in the example table of FIG. 10. With respect to network 202, these trajectory probabilities are indicated in the table of FIG. 11 for any two vertices Vᵢ and Vⱼ. Each probability Pₖ may then be multiplied by the tie strength of a given trajectory Tₖ described above to calculate a modified trajectory probability 124, the probability PTₖ. Tie strengths for each pair of vertices Vᵢ and Vₖ of network 202 are indicated in the example table of FIG. 12. This modified trajectory probability 124 may be calculated as follows:

$${PT}_{k} = {P}_{k} * {T}_{k}$$

With respect to network 202, these modified trajectory values are indicated in the example table of FIG. 13. From this modified trajectory probability 124, the overall probability of an information flow from Vᵢ to Vⱼ via K(i, j) trajectories may calculated as follows:

$$Prob ( i , j ) = {\sum }_{K = 1}^{K ( i , j )} {PT}_{k}$$

From this probability, trajectory entropic values for the information flow from Vᵢ to Vⱼ may calculated as follows:

$$TE ( i , j ) = - {\sum }_{j = 1}^{n - 1} Prob ( i , j ) log Prob ( i , j )$$

Thus, the trajectory entropic value for N symbols passing through a network comprised of a plurality of vertices, such as example network 202, is determined as follows:

$$TE = {\sum }_{\begin{matrix}i = 1 \\ j = 1\end{matrix}}^{N} TE ( i , j )$$

This trajectory entropic value may be computed for each combination of vertices, as illustrated in the example table of FIG. 14, which lists the trajectory entropic values for each combination of vertices (Vᵢ, Vⱼ). As mentioned above, these trajectory entropic values may be used to determine the accessibility potential and propagation potential of each vertex or node of the network.

Accessibility potential refers to the ability of a vertex to access information based on all the dynamic paths that lead to a vertex in the network from all the other vertices within the network. Similarly, propagation potential refers to the ability of a vertex to propagate information to all other vertices within the network based on all the dynamic paths that start from a vertex and lead to all the other vertices in a network.

Let H_{T}(i,j) be an N×N matrix of trajectory entropic_values of all possible trajectories between a vertex Vᵢ and vertex Vⱼ. In the example embodiment, these values may be found in the table of FIG. 14. Accessibility potential of a vertex i is defined as follows:

$$AP ( i ) = {\sum }_{i = 1}^{N} {H}_{T} ( i , j )$$

where N is the number of vertices in the network. Similarly, the propagation potential of the given vertex i is defined as follows:

$$PP ( i ) = {\sum }_{j = 1}^{N} {H}_{T} ( i , j )$$

Thus, the accessibility potential (AP) is the sum of columns of trajectory entropic values in matrix H_{T}(i, j), and the propagation potential (PP) is the sum of rows of trajectory entropic values in matrix H_{T}(i, j). These values can indicate relative positional encoding within data. With respect to the example network 202, the accessibility potential and propagation potential are shown in the table of FIG. 15. Each example accessibility potential of FIG. 15 may be computed by adding all the columns from FIG. 14 of each indicated vertex, and each example propagation potential may be computed by adding all the rows from FIG. 14 of each indicated vertex.

In case of a word network (such as a large language model or LLM), accessibility potential is the likelihood of a word i occurring before word j. Similarly, the propagation potential is the likelihood of a word i occurring after word j. In case of a people network (such as a network configured to process and/or analyze a social media feed) it indicates who consumes information from whom and who propagates information to whom.

The sums of each row and the sums of each column provide values PP and AP, respectively, which indicate the total entropic value generated by a vertex. Dynamic entropy values indicate how freely a vertex can communicate (PP) as well as gather information (AP) within the network. These values take into consideration the capacity of a vertex to form connections (degree), the accessibility of a vertex (average distance information needs to travel from one to any other vertex in the network), and ways of accessing a vertex (in this case, all the shortest paths possible between vertices (geodesic)). At the same time, the values also take into consideration the determination making (preferential attachment through tie strength) abilities of the vertices in the network. As a result, the entropic values can convey information, which traditionally needed multiple centrality measures (degree, closeness, betweenness, and eigenvalue). Due to reasons mentioned above, this metric is able to keep track of multiple dynamic changes happening within the network. The change in collective entropic values also indicates the momentum of information exchange and its impact. Thereby, it can be used to predict changes within a network.

Finally, to the extent the foregoing methods and techniques are presented in the context of particular network configurations, this should not be taken as limiting. The foregoing methods and techniques may be applied for any sort of suitable trajectory, e.g. any combination of route(s) and/or method of propagation through a network.

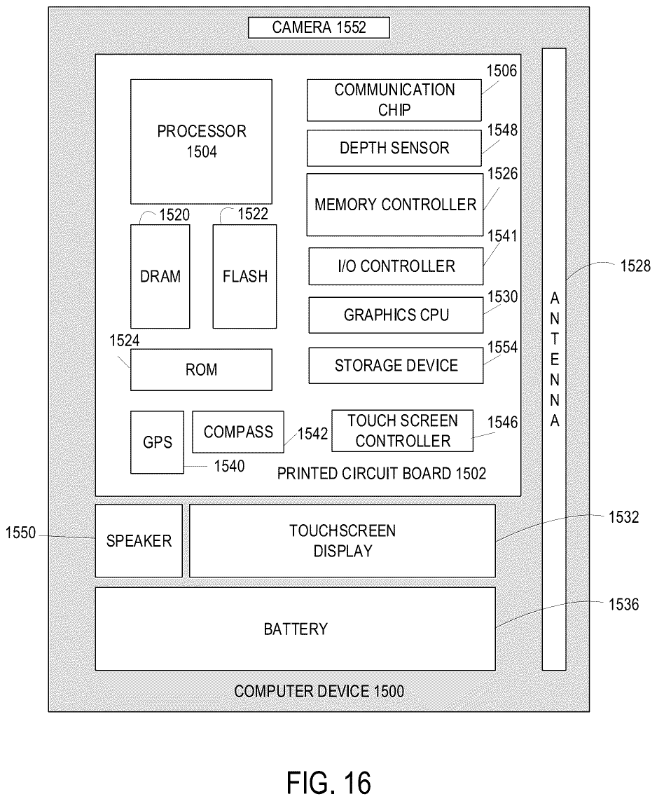

FIG. 16 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of process flow 100 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

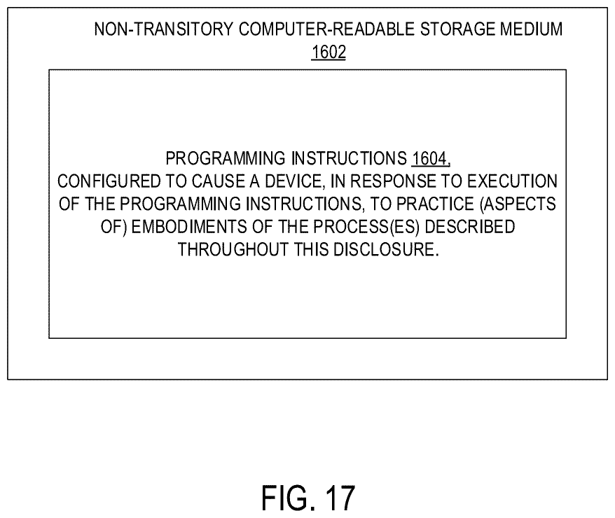

FIG. 17 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) process flow 100, described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for calculating a trajectory entropy of a network, comprising:
receiving an input matrix of the network, the network comprised of a plurality of vertices and a plurality of edges;
calculating, from the input matrix, an adjacency matrix;
calculating, from the adjacency matrix, a number of trajectories between all vertices of the plurality of vertices;
calculating trajectory probabilities of the number of trajectories; and
determining, from the trajectory probabilities, a trajectory entropy for each trajectory between any two of the plurality of vertices.

2. The method of claim 1, wherein the network is a directed network.

3. The method of claim 2, wherein the directed network is a weighted directed network.

4. The method of claim 1, further comprising determining, for each vertex, an accessibility potential and a propagation potential.

5. The method of claim 1, wherein calculating an adjacency matrix comprises calculating a plurality of adjacency matrices, each of the plurality of adjacency matrices corresponding to an order of adjacency.

6. The method of claim 1, further comprising receiving a tie strength matrix, and calculating the trajectory probabilities of the number of trajectories comprises:
generating, from the tie strength matrix, a normalized tie strength matrix; and
calculating, from the tie strength matrix and the number of trajectories, a trajectory tie strength matrix.

7. The method of claim 6, further comprising generating, from the trajectory tie strength matrix and the trajectory probabilities, a modified trajectory probability matrix.

8. A non-transitory computer-readable medium comprising instructions that, when executed by one or more processors, cause the one or more processors to perform:
receiving an input matrix of a network, the network comprised of a plurality of vertices and a plurality of edges;
calculating, from the input matrix, an adjacency matrix;
calculating, from the adjacency matrix, a number of trajectories between all vertices of the plurality of vertices;
calculating trajectory probabilities of the number of trajectories; and
determining, from the trajectory probabilities, a trajectory entropy for each trajectory between any two of the plurality of vertices.

9. The non-transitory computer-readable medium of claim 8, wherein the network is a directed network.

10. The non-transitory computer-readable medium of claim 9, wherein the directed network is a weighted directed network.

11. The non-transitory computer-readable medium of claim 8, wherein the instructions further cause the one or more processors to perform determining, for each vertex, an accessibility potential and a propagation potential.

12. The non-transitory computer-readable medium of claim 8, wherein calculating an adjacency matrix comprises calculating a plurality of adjacency matrices, each of the plurality of adjacency matrices corresponding to an order of adjacency.

13. The non-transitory computer-readable medium of claim 8, wherein the instructions further cause the one or more processors to perform receiving a tie strength matrix, and calculating the trajectory probabilities of the number of trajectories comprises:
generating, from the tie strength matrix, a normalized tie strength matrix; and
calculating, from the tie strength matrix and the number of trajectories, a trajectory tie strength matrix.

14. The non-transitory computer-readable medium of claim 13, wherein the instructions further cause the one or more processors to perform generating, from the trajectory tie strength matrix and the trajectory probabilities, a modified trajectory probability matrix.

15. A system for determining trajectory entropies of a network, comprising:
one or more processors; and
a storage medium in data communication with the one or more processors, the storage medium containing instructions that, when executed by the one or more processors, cause the system to perform:
receiving an input matrix of the network, the network comprised of a plurality of vertices and a plurality of edges;
calculating, from the input matrix, an adjacency matrix;
calculating, from the adjacency matrix, a number of trajectories between all vertices of the plurality of vertices;
calculating trajectory probabilities of the number of trajectories; and
determining, from the trajectory probabilities, a trajectory entropy for each trajectory between any two of the plurality of vertices.

16. The system of claim 15, wherein the network is a directed network.

17. The system of claim 15, wherein the instructions further cause the one or more processors to perform determining, for each vertex, an accessibility potential and a propagation potential.

18. The system of claim 15, wherein calculating an adjacency matrix comprises calculating a plurality of adjacency matrices, each of the plurality of adjacency matrices corresponding to an order of adjacency.

19. The system of claim 15, wherein the instructions further cause the one or more processors to perform receiving a tie strength matrix, and calculating the trajectory probabilities of the number of trajectories comprises:
generating, from the tie strength matrix, a normalized tie strength matrix; and
calculating, from the tie strength matrix and the number of trajectories, a trajectory tie strength matrix.

20. The system of claim 19, wherein the instructions further cause the one or more processors to perform generating, from the trajectory tie strength matrix and the trajectory probabilities, a modified trajectory probability matrix.
